(19) United States
(12) Patent Application Publication
(10) Pub. No.: US 2017/0147759 A1
(43) Pub. Date: May 25, 2017

(54) Patient Centered Medical Home for Perioperative Hospital Surgical Care

(71) Applicants: Raj R. Iyer, Naperville, IL (US); Bryan W. Rubach, Naperville, IL (US)

(72) Inventors: Raj R. Iyer, Naperville, IL (US); Bryan W. Rubach, Naperville, IL (US)

(21) Appl. No.: 15/361,350

(22) Filed: Nov. 25, 2016

Related U.S. Application Data
(60) Provisional application No. 62/309,722, filed on Mar. 17, 2016.
(60) Provisional application No. 62/259,299, filed on Nov. 24, 2015.

(51) Int. Cl. G06F 19/00

(52) U.S. Cl. CPC G06F 19/325; G06F 19/322; G06F 19/327; G06F 19/363

(57) ABSTRACT

A perioperative healthcare management system accessible by a plurality of healthcare providers to collect information related to a patient includes a processor, a database for storing data related to a plurality of patients, and a memory coupled to the processor. The memory is configured to store program instructions executable by the processor, and, in response to executing the program instructions, the processor is configured to generate a dashboard including a plurality of regions, each region corresponding to one of a plurality of modules of perioperative care.

### CROSS-REFERENCE TO RELATED APPLICATION

This application claims the benefit of priority to U.S. Provisional Application No. 62/259,299 filed on Nov. 24, 2015, and U.S. Provisional Application No. 62/309,722 filed on Mar. 17, 2016, the disclosures of which are incorporated herein by reference.

### BACKGROUND OF THE INVENTION

The present subject matter relates to a screening system that coordinates patient assessment and plans of care between a multitude of healthcare providers throughout the perioperative journey. More specifically, the present invention relates to a centralized interactive system that provides for the screening, assessment, ensuring of treatment, longitudinal following of patients and enhanced sharing of patient information with all caregivers.

Sleep apnea is a sleep disorder characterized by pauses/absence (apneas) in breathing or instances of shallow or infrequent breathing (hypopneas) during sleep. This disorder is related to serious health issues including heart disease, high blood pressure, diabetes, strokes, rhythm disturbances of the heart, kidney disease/failure, and complications with medications and/or surgery. In the United States, it is estimated that 22 million people suffer from sleep apnea, with about 82 to 93 percent of these cases undiagnosed. The life expectancy of untreated obstructive sleep apnea (OSA) is only 58 years of age. The high incidence of undiagnosed cases may result in part from the limited screening for the disorder, inadequate education, and lack of vigilance to diagnose the disorder and follow up with patients regarding treatment. The problem of undiagnosed patients is compounded by a lack of education of the public on the serious health consequences of OSA. Even where patients are properly diagnosed, many patients who are instructed to undergo continuous positive airway pressure (CPAP) therapy often have difficulty complying with and continuing the prescribed therapy.

Doctors typically diagnose sleep apnea based on medical and family histories, a physical exam, and sleep study results. However, many primary care physicians are not aware of what symptoms to look for, particularly in some classes of high risk patients, and therefore these patients fail to be diagnosed and properly treated. Doctors may screen patients by asking the patient's family members to keep a sleep diary for a few weeks as they tend to be most affected by the loud snoring (a cardinal sign for OSA) along with the fact that most of these patients are completely unaware of their disease. In this diary, information about how much sleep the patient gets each night, how alert and rested the patient feels in the morning, and how sleepy they feel at various times during the day is recorded.

Another well-validated screening tool is a questionnaire referred to as the “STOP-BANG questionnaire”, which includes targeted questions that would be kept in their sleep diary. The STOP-BANG questionnaire is widely accepted as a reliable, concise screening tool. It includes eight yes/no questions related to the clinical features of sleep apnea that are allotted points to provide a total score that corresponds to the level of risk. For example, a score of 0-2 corresponds to a low risk patient, a score of 3-4 corresponds to an intermediate risk patient, and a score of 5-8 corresponds to a high-risk patient.

In the next step, the doctor performs a physical exam to look for physical attributes that are highly suggestive for OSA. Indicators include obesity, large neck, large tongue for the person's mouth, large deposits of fat in the cheeks and throat of the patient, large tonsils and adenoids, to name a few.

Once the doctor concludes from the screening and the physical exam that the patient is at high risk for OSA, he orders a sleep study, which is typically required by insurance companies to cover the cost of the patient's CPAP machine. The most common type of sleep study is known as a Polysomnogram (PSG), performed in a lab setting, that monitors brain activity (EEG), eye movements (EOG), heart rate (ECG), blood pressure, blood oxygen levels (SpO2), air movement through the nose and mouth by capturing the end-expired capnogram (the patient's expired CO2), snoring, and chest movements. The time-consuming nature and inconvenience of the PSG often discourages the patient from moving forward. Another, more convenient sleep test called the Home Sleep Test (HST) may be used, which can be done at the patient's home.

Both PSG and the HST are time-consuming and involve a lot of paperwork and coordination with various healthcare providers, including multiple visits to different hospitals, clinics, and/or offices. This involved process creates a burden on the primary care physician as well as the patient. Further, the traditional sleep apnea diagnosis steps discussed above take time to coordinate, are delayed by lags in insurance approval, and coupled to a system that makes it hard for patients to comply.

Undiagnosed cases become a serious concern with an undiagnosed patient undergoes an unrelated surgery. Patients with sleep apnea are much more likely to experience adverse respiratory and cardiovascular events following major surgery. In a worst case scenario, a patient suffering from sleep apnea needs a pain medication that sedates him, and is sedated without the proper monitoring and stimulation needed to address the OSA, leaving him untreated at a time of his greatest risk.

In addition to the value in effectively sharing patient information between the multitude of caregivers during the perioperative process, the patient data is also valuable for obtaining government funding via Medicare. According to the Center for Medicare and Medicaid Services (CMS), costly re-admissions may result from poor quality of care, inadequate coordination of care, and lack of effective discharge planning and transitional care. OSA patients are one subgroup of patients at high risk for re-admission.

In recent years, Medicare has moved from a fee per service payment model to more outcome based payments, focusing on value-based reimbursement. This shift in payment model includes voluntary and mandatory data reporting requirements for healthcare providers. Accountable Care Organizations (ACOs) are groups of doctors, hospitals, and other healthcare providers who voluntarily give coordinated high-quality care to Medicare patients. If an ACO succeeds both in delivering high-quality care and effective spending of healthcare dollars, the federal government will share the savings it achieves for the Medicare program with the ACO through the Medicare Shared Savings Program.

To provide the coordinated high-quality care required by ACOs and by physician groups, data must be shared among healthcare providers and reported to the government. The Physician Quality Reporting System (PQRS) is a quality reporting program that encourages individual and group practices to report information on the quality of care to the CMS. PQRS provides participating practices and CMS with the opportunity to assess the quality of care provided to patients, helping to ensure that patients get the right care at the right time. By reporting on PQRS quality measures, individual and group practices can quantify how often they are meeting pre-defined quality metrics. Importantly, these measures are related to the Meaningful Use measures as defined by the CMS relative to the certified electronic health record technology. “Meaningful Use” is a CMS Medicare and Medicaid program that awards incentives for using certified electronic health records to improve patient care. To achieve Meaningful Use standards and avoid penalties, providers must follow a specific set of criteria. If these metrics are not satisfied, Medicare will apply a negative payment adjustment to those individual and group practices that failed to satisfy the quality metrics.

Accordingly, there is a need for a centralized computerized perioperative healthcare management system that screens patients, coordinates care, heightens the quality of care, and creates effective discharge planning and transitional care.

### BRIEF SUMMARY OF THE INVENTION

To meet the needs described above and others, the present disclosure provides a perioperative healthcare management system designed for various healthcare providers to improve the coordination and sharing of information when screening, assessing, and treating sleep apnea for patients about to undergo surgery. This increased coordination allows for more effective treatment and management of the condition, serves to prevent major post-op complications, unintended ICU admissions, admissions, re-admissions, while also improving reporting measures that can be captured and reported to Medicare.

Throughout the perioperative journey, the patient meets with various healthcare professionals at different points in the process to evaluate the patient's health, provide/collect information, and discuss plans of care. The perioperative journey can be categorized into stages, from the pre-admission stage through the discharge stage. The perioperative healthcare management system includes a plurality of modules that correspond to each stage of the perioperative journey.

In a preferred embodiment, the perioperative healthcare management system may exist as a hosted website and/or mobile device application accessible via the internet. The system may be centered around an interactive virtual dashboard, displayed to a user upon log-in to the website or mobile application and will be patient-centric throughout its application. The dashboard features a series of regions correspond to the modules of the perioperative healthcare management system. Each region is as a clickable link that leads to a corresponding form on a separate user interface. The healthcare provider involved the relevant stage of the perioperative treatment inputs and reviews patient data, or such patient data may be pulled from various existing hospital systems with appropriate interphases that communicate with these systems. The forms may resemble a standard web response form, with prompts and response fields to be filled in via free response and/or drop down list. Once filled out, the user saves the data into the system's database.

The associated healthcare professionals may include a primary care provider, a sleep lab or sleep specialist, day of surgery nurses, operative room nurses, post-operative nurses, pharmacists, respiratory therapists, in-patient ward nurses, the surgeon, an information technology (IT) member, and a risk manager/quality control officer from the hospital, or other relevant providers. Importantly, the perioperative healthcare management system will enable multiple points of oversight by various healthcare providers who will encounter the patient throughout their perioperative journey.

The perioperative healthcare management system ties the temporal steps together through various automated functions to help the healthcare providers involved in treating a patient with sleep apnea by, for example, notifying them with alerts when action is required on their part. The alerts sent out by the system may also be sent as passive, informative messages to all healthcare providers who need to be kept up-to-date with patient treatment information and/or patient feedback. The system may also automate the sharing of information between healthcare providers involved in the different steps of sleep apnea treatment. This automated sharing of information may, as another example, push and pull information from different electronic medical record systems into and out of the computerized sleep apnea screening system. This ability to collate and communicate information needed for sleep apnea treatment across various computerized healthcare platforms aids healthcare providers by ensuring that information that is available to one healthcare provider is available to all who need it and ensure that there is consistent information about patient treatment available to everyone.

In addition to organizing and streamlining the sleep apneic patient's care, this perioperative healthcare management system also features reporting metrics. These metrics are useful not only for healthcare providers to understand on a system wide level how effective their team of healthcare providers are performing, but it also provides information which assists in obtaining healthcare funding from Medicare. The system may record and report metrics about patient compliance, Physician Quality Reporting System (PQRS) measures specific to OSA (with appropriate numerator and denominator values to validate meaningful use measures) and Accountable Care Organizations (ACO) measures. The system may also feature an overview list of all patients in the system and note their respective progress via a progress bar allowing for even further efficient reporting.

An object of the invention is to provide a solution to the issue of many patients being unscreened for sleep apnea before undergoing surgery. Sleep apnea and its related symptoms can cause serious complications (major adverse respiratory and cardiac events) during and after surgery, leading to costly unintended ICU transfers, unintended admissions, re-admissions and up to and including the cardiac arrest and death of a patient.

An advantage of the invention is that it provides a centralized record storage system for sleep apnea screening and treatment information. Currently, the steps involved to screen and treat sleep apnea involve several different visits with several different health care providers. This need for multiple follow up appointments could potentially result in the patient needing to contact multiple healthcare providers multiple times to insure the proper information is provided to all parties. With the current invention, the responsibility of collecting, reviewing, as passing on information about a patient's sleep apnea resides solely with the healthcare team and, importantly, is automated by this platform to drastically reduce workload of all parties involved in the care perioperative care and journey of this OSA patient.

Another advantage on this invention is that the patient's sleep apnea screening and treatment information is readily available to healthcare providers. As mentioned before, sleep apnea diagnosis and treatment requires many different healthcare providers, often working in physically different locations, to work together and share information. This information may include sleep test results, breathing apparatus settings, and which medications the patient has been given over the course of their treatment.

Yet another advantage of this system is that it allows for efficient reporting of healthcare metrics, important for internal and external review. The current invention accounts for metrics relating to patient compliance, Physician Quality Reporting System measures, and hospital Accountable Care Organizations measures.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrate a schematic of the system of the present application.

FIGS. 2A and 2B illustrate a plurality of modules of the system of FIG. 1.

FIG. 3 illustrates a centralized sleep apnea screening system's dashboard.

FIG. 4 illustrates a user interface of a pre-admission module of the system of FIG. 1.

FIGS. 5A-5C illustrate user interfaces demonstrating metrics of the system of FIG. 1.

FIGS. 6A and 6B is a flow chart illustrating the steps of a method of operating the system of the present invention.

### DETAILED DESCRIPTION OF THE INVENTION

The present disclosure is directed to systems 100 and methods 200 for sharing information and prompting communication between the various healthcare professionals 102 involved in the perioperative process of a patient undergoing surgery related to sleep apnea. Although the examples provided in the following description are related to sleep apnea disorders, the present systems 100 and methods 200 may be applied to any disorder or surgical procedure involving the integration of various healthcare professionals.

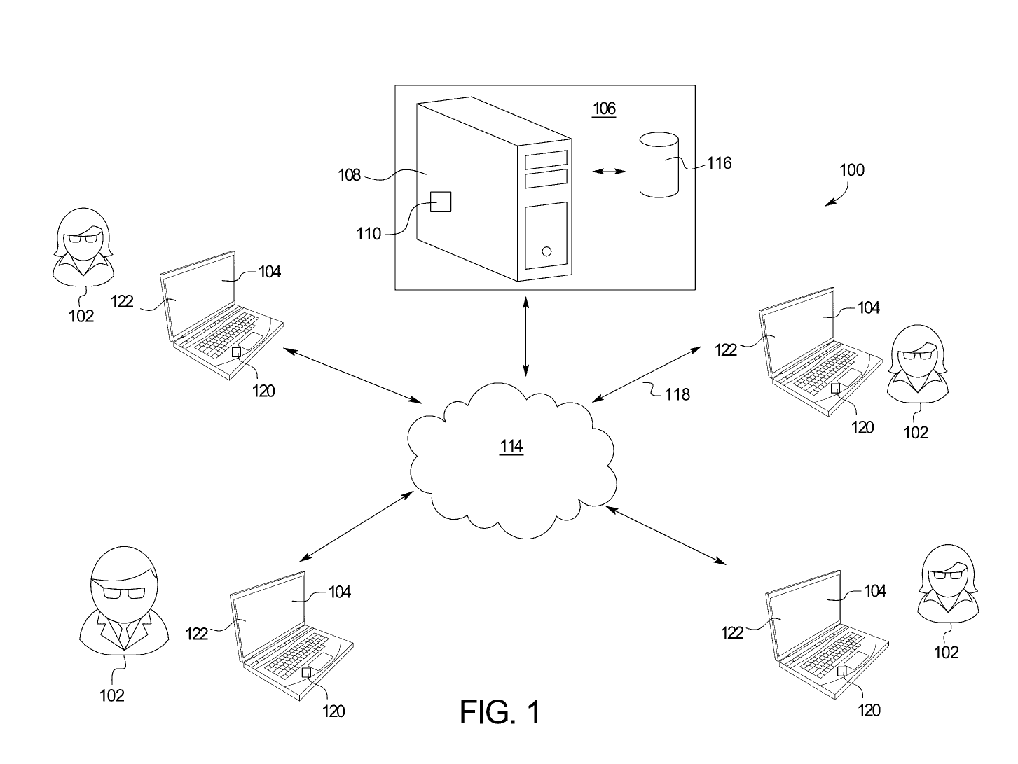

FIG. 1 illustrates an example perioperative healthcare management system 100 for integrating information and communications between healthcare professionals 102, prompting subsequent steps, and deriving associated metrics indicative of each healthcare professional's efficacy. The illustrated example demonstrates the application of the perioperative healthcare management system 100 for a patient diagnosed with obstructive sleep apnea (OSA). The associated healthcare professionals may include a primary care provider, a sleep lab or sleep specialist, day of surgery nurses, operative room nurses, post-operative nurses, pharmacists, respiratory therapists, in-patient ward nurses, the surgeon, an information technology (IT) member, and a risk manager/quality control officer from the hospital, or other relevant providers.

Healthcare professionals 102 may use user devices 104, such as computers, laptops, smart phones, and tablets, to participate. A central system 106 may coordinate the inputting and sharing of information by communicating with the user devices 104. The central system 106 may include a controller 108 with memory 110 configured to store program instructions executable by the controller 108 that may communicate with the user devices 104 through a network 114, such as the internet. A database 116 may be included in the central system 106 to store data during the operation of the system 100. Wired or wireless communication links 118 relay communication between the user devices 104 and the network 114. While the illustrated embodiment shows four healthcare professionals 102 accessing the perioperative healthcare management system 100, any number of healthcare professionals 102 may access the system 100 at any point in time.

In the illustrated embodiment, the user devices 104 may access a web page provided by the central system 106 or may execute a program 122 that provides a user interface 122 for the perioperative healthcare management system 100. The program 122 may be executed by the user devices 104 to enable the respective healthcare professional 102 to input patient data through their user devices 104.

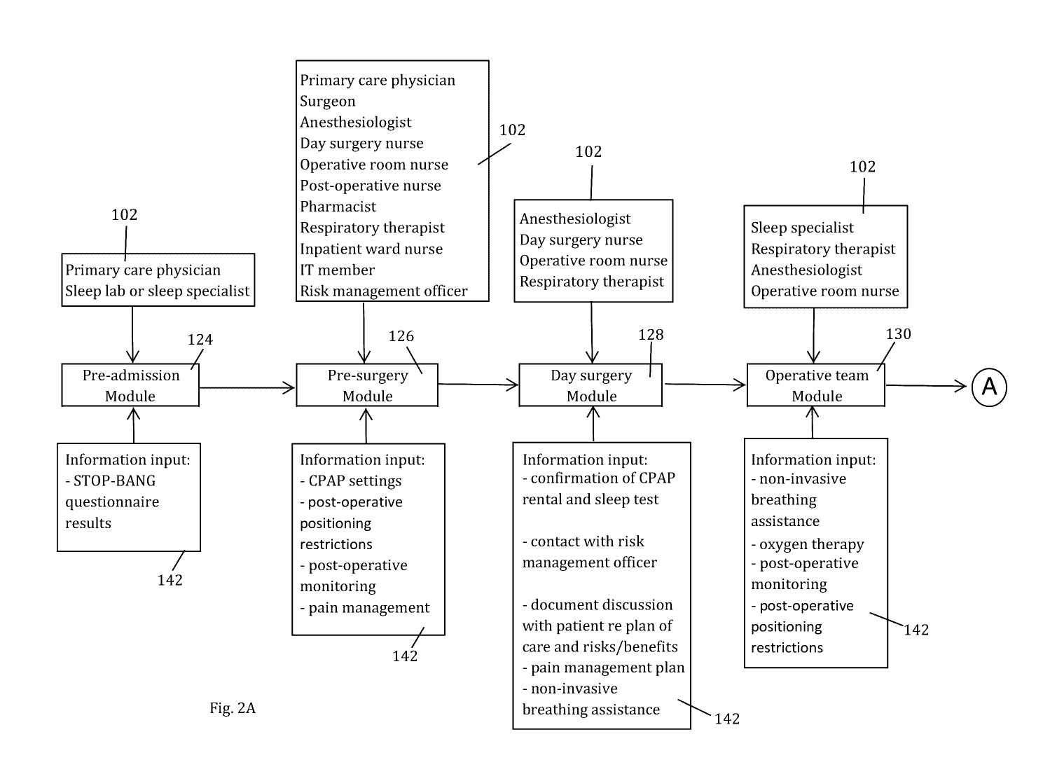

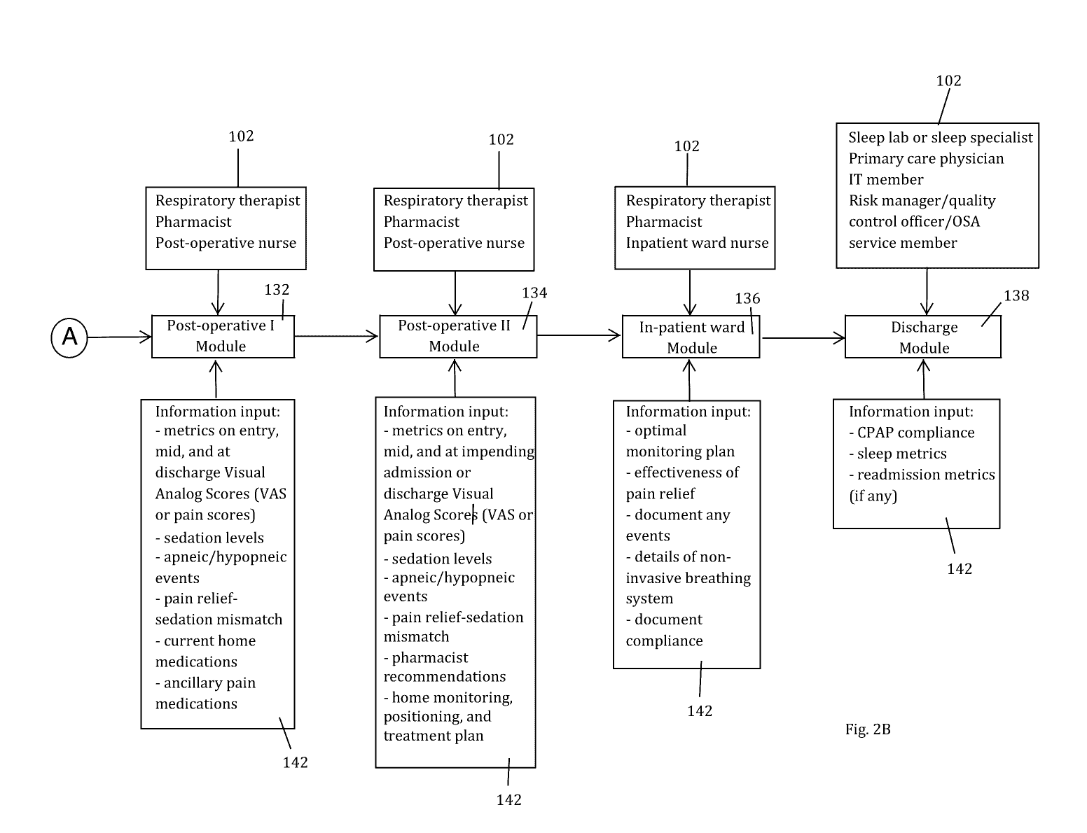

Throughout the perioperative journey, the patient meets with various healthcare professionals at different points in the process to evaluate the patient's health, provide/collect information, and discuss plans of care. The perioperative journey can be categorized into stages, from the pre-admission stage through the discharge stage. Referring to FIGS. 2A and 2B, the perioperative healthcare management system 100 includes a plurality of modules 124-138, with each module 124-138 corresponding to a stage of the perioperative journey. While the healthcare professionals 102 involved in the perioperative journey of a patient may access the patient's file on the perioperative healthcare management system 100 at any time, FIGS. 2A and 2B identifies specific healthcare professionals 102 pertinent to each stage or module 124-138. FIGS. 2A and 2B also show examples of patient data 142 that is input into the perioperative healthcare management system 100 at the various modules 124-138.

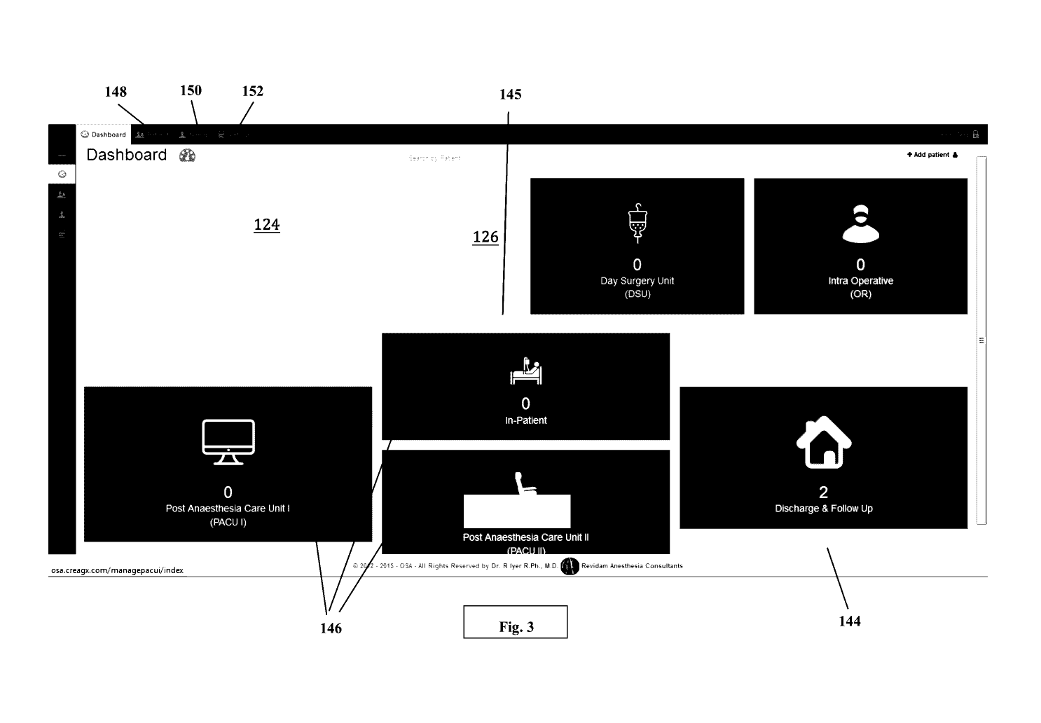

FIG. 3 illustrates an exemplary user interface 144 that serves as the main hub for the perioperative healthcare management system 100. The user interface 144 includes a dashboard 145 with a plurality of regions 146 that each correspond to a module 124-138 of the system 100. The categorization of information into the various modules 124-138 allows for the information 142 to be easily and efficiently recorded and accessed. Each region 146 links to the respective module 124-138, which includes a form for inputting and collecting patient data or information 142. The forms may resemble a standard web form, with blank text box fields that may be filled in by typing and/or drop-down lists. The system 100 may also automatically populate patient data 142 within these forms and send information 142 to other computerized healthcare systems. Also shown in FIG. 3, the user interface 144 includes tabs to access patient records 148, a list 150 of healthcare professionals 102 associated with the perioperative process, and a list of reporting metrics 152. Alerts may also be generated and sent automatically to healthcare professionals in a different portion of the perioperative journey based on patient data 142, informing the relevant healthcare providers of information useful when managing sleep apnea.

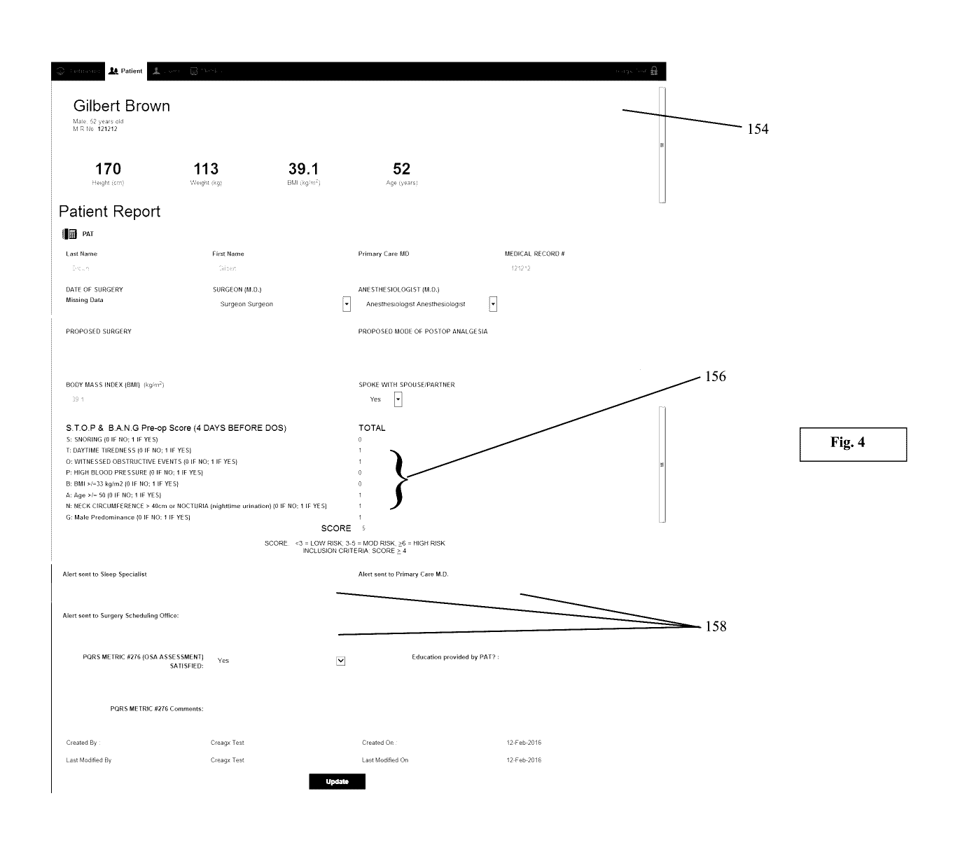

FIG. 4 is a user interface 154 of the pre-admission module 124. As noted in FIG. 2A, the healthcare professionals typically involved at this step are the primary care physician and the sleep lab or specialist. This form may be filled out by a pre-admission team member and include information useful in detecting and treating sleep apnea. The information to be recorded on the pre-admission form may include basic patient information, body mass index (BMI) score, and STOP-BANG questionnaire results 156. Information about whether the patient's various doctors have been contacted, whether sleep apnea education was provided to the patient, and a reporting metric for OSA assessment was carried out for the patient may also be recorded on the pre-admission form. The OSA assessment metric may be satisfied if the patient is at least eighteen years of age with a diagnosis of OSA (clinical diagnosis of OSA) that includes documentation of an assessment of symptoms, including presence of or absence of snoring and daytime tiredness, witnessed obstructive events during sleep, high blood pressure, a minimum BMI, a minimum age, a minimum neck circumference, and gender.

If the STOP-BANG questionnaire results 156 are indicative of the patient being at risk of experiencing sleep apnea, for example, if the score is equal to or greater than 4, the system 100 alerts other healthcare providers 102 involved in the treatment of the patient via automated notification (e.g., by fax, email, SMS, etc.). Each of the sleep specialist, primary care physician, and surgery scheduling office are automatically notified by an alert, and the system 100 may also automatically push data from the sleep apnea screening system 100 to the surgery scheduling office's scheduling software. Further, the user interface 144 includes fields 156 to be populated confirming that alerts have been sent. These alerts 156 serve to notify both healthcare providers 102 currently involved in the patient's treatment as well as healthcare professionals 102 to be involved in the perioperative process at a later date.

At the pre-surgery module 126, the OSA service team may view, input, or update a variety of patient data 142 relevant to the perioperative journey. As shown in FIG. 2B, the OSA service team may include representatives from pre-admissions team, day surgery unit nursing, operative room nursing, post-operative phase I and II nursing, pharmacy, respiratory therapy, in-patient ward nursing, surgeon, primary care physician, an information technology (IT) member, and a risk manager/quality control officer. This team may input and review the patient data 142 at around two days before an expected surgery to perform the first oversight of the information. In a first user interface within the pre-surgery module 126, an overview of this category may display a list of patient names, surgery date, progress of their scheduled or already tested sleep test and its attendant scores, and provide the user ability to access the OSA service team portion of each patient's report. The patient's progress may be displayed as a bar graph allowing users to quickly recognize what step in treatment the patent is currently at.

Healthcare professionals input patient data 142 into a form through a second user interface of the pre-surgery module 126 specific to each patient. Patient data 142 may include patient insurance information, sleep tests results, and sleep specialist recommendations for the patient. Patient data 142 for the pre-surgery module 126 may also include information the perioperative plan, the type of analgesia to be used, CPAP settings, post-operation positioning restrictions, post-operation patient monitoring requirements, and whether education has been provided to the patient. A portion of the second user interface is designated as the First Review to be completed by one of the healthcare professionals, preferably the anesthesiologist.

Pre-surgery assessment metrics, useful for reporting purposes, may also be recorded in the pre-surgery module. Pre-surgery assessment metrics may include an OSA severity metric and information loop metric. The OSA severity metric may be satisfied when a patient is over eighteen years of age, has been diagnosed with OSA, and has had an apnea-hypopnea index (AHI) or respiratory desaturation index (RDI) measured at the time of initial diagnosis. The information loop metric may be satisfied if the patient was referred and the referring provider received a report from the provider to whom the patient was referred.

When this form is completed, the perioperative healthcare management system 100 may then generate an automated alert for a sleep specialist to review and optimize the patient's sleep apnea treatment plan. This plan, along with other relevant information about the patient stored by the system 100, may then be automatically pushed to the day surgery nurse and the respiratory therapist's computer systems by the perioperative healthcare management system 100. This automatic push of data will ensure the healthcare providers have information on the treatment of the patient before the day of their arrival.

The next module is the day surgery module 128. A first user interface displays a list of patients recorded in the centralized perioperative healthcare management system 100. As shown in FIG. 2A, the day surgery healthcare professionals may include the day surgery registered nurse, anesthesiologist or anesthetic team, the operative room registered nurse, and the respiratory therapist. The first user interface includes a list of the patient names, surgery dates, progress, and an indication of the user ability to access the day surgery module of each patient's report. Each patient's progress may be displayed as a bar graph allowing users to quickly see a rough estimate of the amount of patient data that has been input at this stage.

Healthcare professionals input patient data 142 into a form through a second user interface of the day surgery module 128 specific to each patient. The second user interface includes fields for different healthcare providers to record patient data 142 on the day a surgery is to occur. The patient data 142 includes some fields for the day surgery nurse to indicate whether the quality control officer is on notice of the patient, whether a sleep test and/or rental CPAP machines have been accessed pre-operatively by the patient, and whether a visual alert for OSA is present on the electronic medical record (EMR), paper chart, and surgery schedule of the patient. Other patient data 142 to be input includes the anesthesiologist name, whether the surgery plan has been discussed with the patient and their family, the type of breathing treatment (CPAP/BiPAP/Nasal CPAP/O2) expected to be used, post-operative monitoring requirements, the type of pre-operative peri-neural block performed or another regional anesthetic, documentation of discussions with the patient regarding the risks and benefits, post-operation patient positioning, whether a preoperative note on the surgical plan written by the anesthesiologist has been placed on the operative anesthetic record, and whether education has been provided by the day surgery nurse to the patient. A portion of the second user interface is designated as the Second Review to be completed by one of the healthcare professionals, preferably the anesthesiologist. A reporting metric concerning OSA treatment may also be recorded on the DSU form. This metric may be marked as satisfied if the patient is at least eighteen years of age, has a clinical diagnosis of at least moderate OSA, and has received CPAP or is in line to receive therapy.

After the second user interface of the day surgery module 126 is completed, the system sends an automated notification to the respiratory therapist informing them of the patient's impending arrival into post-operative care unit. The operative nurses, the post-operative nurses, the in-patient ward nurse, and pharmacist may also receive this alert or a similar automated notification detailing the information required to best treat the patient.

The subsequent module is the operative team module 130. The operative team module allows the operative room nurse or anesthetic team to perform an advance contact with the respiratory therapist. A first user interface of the operative team module 130 displays a list of patients recorded in the centralized perioperative healthcare management system 100. As shown in FIG. 2A, the operative team healthcare professionals may include the sleep specialist, the respiratory therapist, the anesthesiologist, and the operative room nurse. The first user interface includes a list of the patient names, surgery dates, progress, and an indication of the user ability to access the day surgery module of each patient's report. Each patient's progress may be displayed as a bar graph allowing users to quickly see a rough estimate of the amount of patient data that has been input at this stage.

Healthcare professionals input patient data 142 into a form through a second user interface of the operative team module 130 specific to each patient. The second user interface includes patient data 142 that is relevant to the respiratory therapist when they contact a patient's sleep specialist to confirm plan of care in preparation of patient's arrival to the post-anesthesia care unit (PACU). The patient data 142 input or received by the second user interface includes the CPAP or other relevant settings, the oxygen concentration needed by the patient, the type of monitoring the patient requires, and instructions for patient positioning on recovery in PACU and in-patient ward. A portion of the second user interface is designated as the Third Review to be completed by one of the healthcare professionals, preferably the respiratory therapist. A reporting metric concerning OSA treatment may also be recorded on the second user interface. This metric may be marked as satisfied if the patient is at least eighteen years of age, has a clinical diagnosis of at least moderate OSA, and has received CPAP therapy.

In the next module, a first user interface of the post-operative I module 132 displays a list of patients recorded in the centralized perioperative healthcare management system 100. The post-operative I module enables the post-operative nurse to contact the pharmacy team to enable review of the patient's current home medications, changes in dosage if necessary, withholding of medication if needed, and doses of ancillary pain medications and other adjuvants. As shown in FIG. 2A, the post-operative I healthcare professionals may include the respiratory therapist, the pharmacist, and the post-operative nurse. The first user interface includes a list of the patient names, surgery dates, progress, and an indication of the user ability to access the day surgery module of each patient's report. Each patient's progress may be displayed as a bar graph allowing users to quickly see a rough estimate of the amount of patient data that has been input at this stage.

Healthcare professionals, namely, the post-operative nurses, input patient data 142 into a form through a second user interface of the post-operative I module 132 specific to each patient. These fields may include entry, midpoint, and discharge values for visual analog pain scores, sedation scores, the number of apneic events and the number of pain relief to sedation mismatches. The second user interface may also contain fields for the pharmacy team to record information concerning pharmaceuticals, including medication management for post operation day zero and one (POD 0 and POD 1), any notes on the patients EMR or paper chart, drugs to be used for analgesia, dosing information, dosing limits, adjuvants to be used, doses of adjuvants, total doses of all analgesics given in the OR, and total doses of analgesics. There may also be fields for the pharmacy team to record information about any of the patient's routine home medications and whether they should or not be continued. The respiratory therapist documents the plan of monitoring in either the in-patient or out-patient setting and whether that plan was discussed with the sleep specialist. The second user interface may include fields intended to be utilized by a perioperative nurse as another point of review before the patient is discharged from post-operative I to either in-patient ward or post-operative II (phase II of PACU (pending eventual out-patient discharge)). These fields may include whether the respiratory therapist and pharmacy team have detailed their treatment plan and whether education has been provided by the respiratory therapist to the patient. A portion of the second user interface is designated as the Fourth Review to be completed by one of the healthcare professionals, preferably the perioperative nurse or the post-operative I nurse. A reporting metric concerning the post-operative I may also be recorded on the second user interface. These metrics may include the OSA treatment metric discussed previously as well as the information loop metric discussed previously.

Further, the treatment information captured by the second user interface of the post-operative I module 132 may be populated with data from other healthcare providers' computer systems including the post-operative nurse, the pharmacy team, the respiratory therapist's respective computer systems, once the patient reaches this stage of treatment. When the information is automatically populated or filled out manually by the various healthcare providers, the system 100 may then send an automated notification to the sleep specialist and pharmacy team informing them of the need for them to review the information to confirm it is the best treatment as well as sending an alert to a designated perioperative nurse who would ensure that all healthcare provider's recommendations, recorded in the system, have been complied with.

In the next module, a first user interface of the post-operative II module 134 displays a list of patients recorded in the centralized perioperative healthcare management system 100. The post-operative II module 134 may be used post-surgery to record information useful for OSA management when a patient has extended time in post-operative care. The first user interface of post-operative II module 134 displays the patient names, surgery dates, progress, and access the post-operative II portion of each patient's report. The patient's progress may be displayed as a bar graph allowing users to see a rough estimate of the amount of patient data that has been input at this stage.

Healthcare professionals input patient data 142 into a form through a second user interface of the post-operative II module 134 specific to each patient. The second user interface contains fields to be filled out by the post-operative II nurse. These fields may include visual analog pain score on entry to post-operative II, sedation score on arrival to post-operative II, time spent in post-operative II, number of apneic events which occurred while the patient was in post-operative II, if admission to inpatient care is impending and if any changes to OSA treatment was devised to prevent that unanticipated admission, and discharge instructions specific to OSA treatment/management. The form may also include fields for notes from the pharmacy team. These fields may include the cumulative amount of opioids given to the patient from surgery through post-operative II, notes medication interactions/substitutions for the patient, and notes on medication management for when the patient goes home. The second user interface may also include fields for an anesthesiologist team member to record the optimal analgesia and treatment plan for the patient upon discharge home as well as fields for sleep specialist notes. These fields may specifically include notes pertaining to the patient's treatment upon discharge home, the optimal monitoring plan, the optimal positioning plan, the optimal treatment plan, when a PSG is to be scheduled or when the HST is to be performed by the patient on which day(s) post discharge home, when and where follow up appointments with the patient's primary care doctor are to take place, and if education has been provided by the post-operative II team to the patient. A portion of the second user interface is designated as the Fifth Review to be completed by one of the healthcare professionals, preferably the anesthesiologist, regarding the optimal analgesia and treatment plan on discharge to home. Fields to record information regarding metrics, useful for reporting purposes, may also be found on the second user interface. These metrics may include the information loop metric as well as an OSA follow up plan metric. The OSA follow up metric maybe satisfied if the patient is greater than eighteen years of age, clinically diagnosed with OSA, was treated with CPAP, and has documentation that adherence to CPAP therapy was objectively measured.

The system may auto-populate the second user interface of the post-operative II module 134 with information stored in the post-operative II nurse, the pharmacy team, the respiratory therapist, and the sleep specialist's computerized systems. Further, the system 100 may also notify the sleep specialist, the primary care physician, and the risk manager that a patient is going to be discharged or sent to inpatient care, and that these healthcare providers have upcoming tasks which need to be carried out in order to provide the best treatment possible.

In the next step, the first user interface of the in-patient ward module 136 includes a listing of patients recorded in the perioperative healthcare management system 100. The in-patient ward module 136 is used post-surgery to record information useful for OSA management when a patient has entered in-patient care. The first user interface displays patient names, surgery dates, progress, and access the in-patient ward portion of each patient's report. Each patient's progress may be displayed as a bar graph allowing users to see a rough estimate of the amount of patient data that has been input at this stage.

Healthcare professionals input patient data 142 into a form through a second user interface of the in-patient ward module 136 specific to each patient. The second user interface may include fields intended to be filled out by an in-patient ward nurse. These fields may include information about if monitors were placed on the patient, patient care notes, and pain scale information collected from the patient. The fields pertaining to monitor information may specifically include if electrocardiogram (ECG), oxygen saturation, and/or exhaled breath carbon dioxide monitors were placed on the patient and if any alarms sounded from these monitors. The fields pertaining to patient care notes may specifically include: positioning of the patient, if an unintended transfer to the ICU occurred, and if a patient suffered a major respiratory or cardiac event (medical response team event where the rapid response team is summoned due to patient duress) while in the in-patent ward. The pain scale information fields may specifically include visual analogue pain scores (VAS scores) reported by the patient during their first day in the in-patient ward at regular intervals (four hours after admission to the ward, eight hours after admission, and at night on the first day of admission). There may also be fields included on the in-patient ward nurse portion of the form for any major respiratory events and any major cardiac events the patient suffers. The in second user interface may also include fields for a respiratory therapist to record patient treatment notes. These fields may specifically include CPAP mode, CPAP settings, fraction of inspired oxygen percentage used, if the patient complied with OSA treatment on day zero and day one of admission to the in-patient warm, the hours and percentage of compliance to the OSA treatment, patient positioning, if patient accepted the CPAP treatment, and any alternatives used if patient was not compliant with the treatment. The second user interface may also feature fields for a pharmacy team member to make notes about the adequacy of analgesia given to the patient. These fields may include patient's reported pain score at bedtime on day zero of entering the in-patient ward, the total doses of opioids given to the patient until the morning of day one of the patient being in the in-patient ward, the pain score reported by the patient during the morning of day one of the patient being in the in-patient ward, any drug interactions, the total doses of adjuvants given up to the morning of day one of the patient being in the in-patient ward, if suboptimal analgesia had been given to the patient, any solutions given to the patient, and if the patient had elevated sedation scores. The second user interface may also feature fields for a sleep specialist's notes. These notes may be made on day zero or day one of the patient entering the in-patient ward and the fields may include treatment instructions for patient on discharge, positioning instructions for patient on discharge, follow up instructions for patient on discharge, and if these notes are present in the EMR/on the paper chart to the patient's primary care doctor. The second user interface may also include fields for if education was provided to the patient upon in-patient admission and for recording information on if different metrics, useful for reporting purposes, have been satisfied. These metrics may include the OSA follow up plan metric as well as the information loop metric.

The information present on the second user interface may be pulled, like several of the other forms stored by the system, automatically from the various healthcare providers involved in the patient's treatment. A portion of the second user interface is designated as the Sixth Review to be completed by one of the healthcare professionals, preferably the pharmacy team.

In the next module, a first user interface of the discharge module 138 displays a listing of patients recorded in the perioperative healthcare management system 100. The discharge and follow up category may be used by a sleep specialist, the patient's primary care physician, an IT member, and a quality control officer or risk manager after the patient is discharged from the hospital following a surgery. The first user interface includes a list of the patient names, surgery dates, progress, and an indication of the user ability to access the day surgery module of each patient's report. Each patient's progress may be displayed as a bar graph allowing users to quickly see a rough estimate of the amount of patient data that has been input at this stage.

Healthcare professionals input patient data 142 into a form through a second user interface of the discharge module 138 specific to each patient. The second user interface may be used by a sleep lab or specialist to record information about the patient's compliance with CPAP therapy post-discharge (i.e., the rental CPAP the patient received as the patient's eventual permanent CPAP would be pending testing). The second user interface receives patient data 142 such as whether the patient has complied with CPAP treatment after discharge, the percentage of compliance the patient has carried out with a home sleep test, the percentage of compliance the patient has carried out after CPAP titrations, and if the patient has still complied with the treatment during periodic checks throughout the first year post surgery. These fields would be accessible from the sleep specialist to input general data about the number of patients they have seen with above and below seventy percent compliance lab data.

The patient's primary care physician also inputs patient data 142 into the second user interface of the discharge module 138 related to whether the doctor provided a note to sleep specialist if there are any diabetes or hemoglobin A1c (HbAIC) changes for the patient, whether there are any high blood pressure control changes for the patient, whether there are any cardiac disorders control changes for the patient, and whether education on body mass index (BMI) and obesity have been provided to the patient.

Still further, an OSA risk manager may use the second user interface to record general information such as whether there was any re-admission within 30 days of the index admission, any major post-op complications, any unplanned ICU admissions or unplanned admissions and hospital length of stay. The second user interface may also include fields for if education was provided to the patient upon discharge and follow-up as well as fields for recording information on if different metrics, useful for reporting purposes, have been satisfied. These metrics may include the OSA follow up plan metric as well as the information loop metric.

The information recorded in the discharge and follow up form may be populated over time automatically based off information stored in the computerized systems of the sleep specialist, primary care physician, and risk manager. As with all the forms stored by the system, the information may also be entered manually if no automatic communication of the relevant information is possible. A portion of the second user interface is designated as the Seventh Review to be completed by one of the healthcare professionals, preferably the IT specialist.

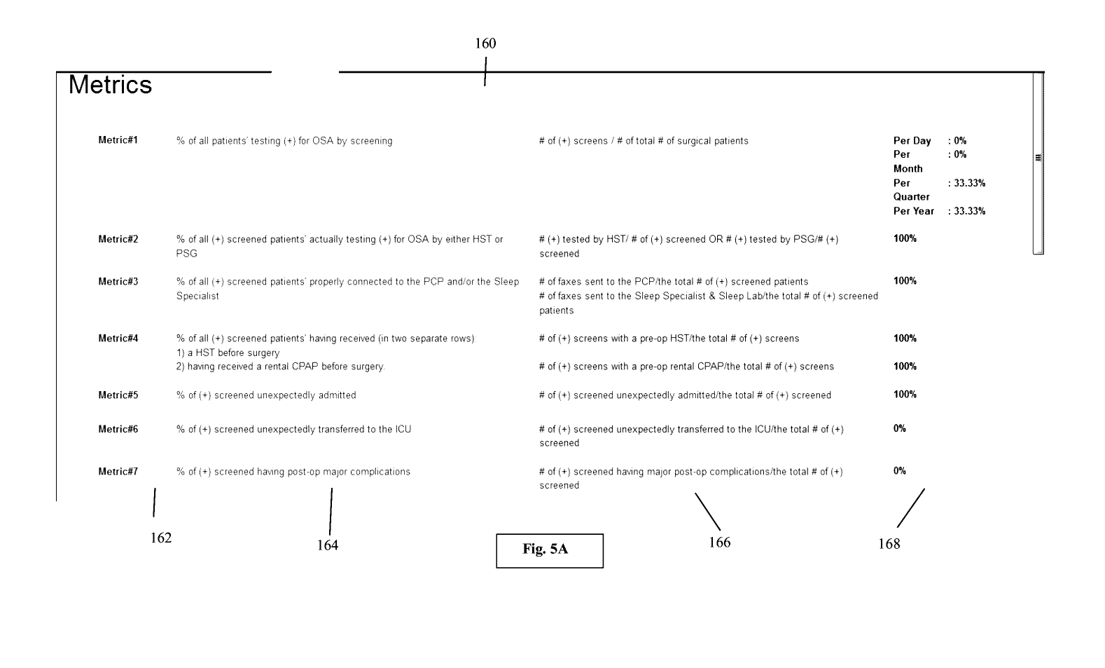

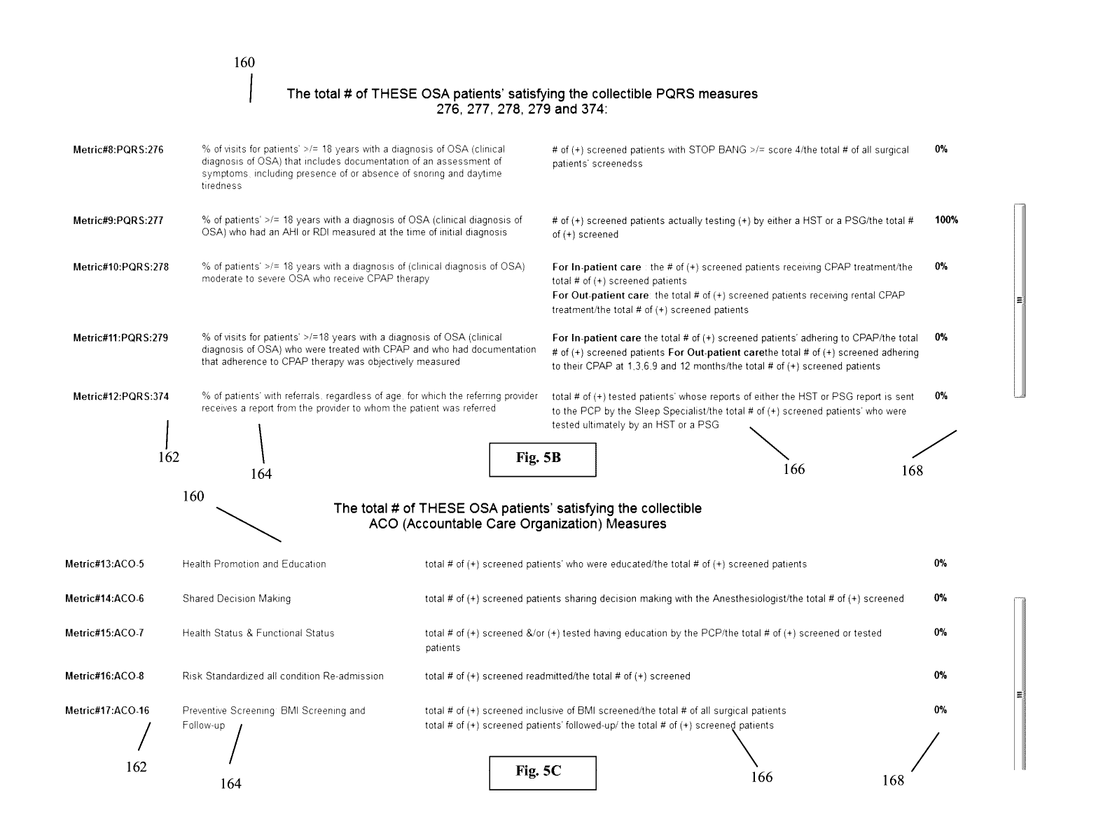

FIGS. 5A-5C illustrate the metrics 160 developed by the perioperative healthcare management system 100 that are useful for reporting purposes. The metrics 160 of the present application include a title 162, an explanation 164, a formula 166, and a numerical value(s) 168.

In the illustrated embodiment, the metrics 160 may be split up into three categories 160a-160c. The first category 160a shown in FIG. 5A is a set of basic metrics 160 concerning patients in the screening system. The metrics 160a may include the percentage of all patients' testing positive for OSA by screening, the percentage of all positive screened patients' actually testing positive for OSA by either HST or PSG, the percentage of all positive screened patients' properly connected to the primary care physician and/or the sleep specialist, the percentage of all positive screened patients' having received a HST before surgery, the percentage of all positive screened patients' having received a rental CPAP before surgery, the percentage of positive screened patients unexpectedly admitted, the percentage of positive screened patient unexpectedly transferred to the ICU, and the percentage of positive screened having post-op major complications.

The second category 160b shown in FIG. 5B is a set of basic metrics 160 concerning physician quality reporting system (PQRS) measures. The metrics 160b include the percentage of patients at least eighteen years of age with a diagnosis of OSA (clinical diagnosis of OSA) that includes documentation of an assessment of symptoms; the percentage of patients over eighteen years of age, diagnosed with OSA, and had an apnea-hypopnea index (AHI) or respiratory disturbance index (RDI) measured at the time of initial diagnosis; the percentage of patients at least eighteen years of age with a clinical diagnosis of at least moderate OSA and have received CPAP therapy; the percentage of patients greater than eighteen years of age, clinically diagnosed with OSA, treated with CPAP, and have documentation that adherence to CPAP therapy was objectively measured; and the percentage of patients referred with the referring provider receiving a report from the provider to whom the patient was referred.

The third category 160c shown in FIG. 5C is a set of basic metrics 160 concerning accountable care organization (ACO) measures. The metrics listed may include health promotion and education, shared decision making, health status and functional status, risk of readmission, BMI screenings, and follow-ups.

Exemplary descriptions of the metrics 160 illustrated in FIGS. 5A-5C are provided below.

Metric #1:
Entitled—“% of all patients' testing (+) for OSA by screening”
Formula—# of (+) screens/# of total # of surgical patients′; and
Results—% per day, per month, per quarter, and per year
Data source—the pre-admissions module where each individual patient is scored with the STOP BANG; those with (+) scores would be the numerator and the denominator would be the total # of patients per that day, then per that week, then per quarter, then per month and then per year.

Metric #2:
Entitled—“% of all (+) screened patients' actually testing (+) for OSA by either HST or PSG”
Formula—# (+) tested by HST/# of (+) screened and # (+) tested by PSG/# (+) screened
Results—the actual % for the (+) HST value and the actual % for the (+) PSG value
Data source—the pre-surgery module section where the sleep specialist would note the values for the HST or PSG when they eventually get performed.

Metric #3:
Entitled—“% of all (+) screened patients' properly connected to the PCP and/or the Sleep Specialist”
Formula—# of faxes sent to the PCP/the total # of (+) screened patients' and the # of faxes sent to the Sleep Specialist & Sleep Lab/the total # of (+) screened patients′.
Results—the actual % of the contacts/faxes noted to the PCP and the Sleep Lab & Sleep Specialist
Data source—the pre-admissions module where they send fax contacts to the PCP and Sleep Specialist & Sleep Lab.

Metric #4:
Entitled—“% of all (+) screened patients' having received (in two separate rows): 1) a HST before surgery and 2) having received a rental CPAP before surgery.”
Formula—# of (+) screens with a pre-op HST/the total # of (+) screens and the # of (+) screens with a pre-op rental CPAP/the total # of (+) screens.
Results—the actual % of these received HST and received rental CPAP
Data source—the day surgery module where the day surgery nurse would note the receipt of these or not

Metric #5:
Entitled: “% of (+) screened unexpectedly admitted”; below this in the left column
Formula: # of (+) screened unexpectedly admitted/the total # of (+) screened
Results: row the actual % of screened unexpectedly admitted/total screened
Data source—the post-operative II module where the post-operative II nurse notes unexpected admission or not

Metric #6:
Entitled—“% of (+) screened unexpectedly transferred to the ICU”;
Formula—the # of (+) screened unexpectedly transferred to the ICU/the total # of (+) screened (
Results—the actual % of screened unexpectedly admitted/total screened
Data source—the in-patient ward module where the in-patient ward nurse notes an unexpected transfer to the ICU or not)

Metric #7:
Entitled—“% of (+) screened having post-op major complications”
Formula—the # of (+) screened having major post-op complications/the total # of (+) screened
Results—the actual % of screened having major post-op complications/total screened
Data source—the in-patient ward module where the patient ward nurse notes an MRT or not

Metric #8: PQRS #276;
Entitled—“% of visits for patients' >/=18 years with a diagnosis of OSA (clinical diagnosis of OSA) that includes documentation of an assessment of symptoms, including presence of or absence of snoring and daytime tiredness”
Formula—the # of (+) screened patients with STOP BANG>/=score 4/the total # of all surgical patients' screened.
Results—the actual % of screened patients with STOP BANG>/=score 4/the total # of all surgical patients' screened
Data source—the pre-admissions module where the pre-admissions team notes the score of the STOP-BANG questionnaire and all meeting the inclusion criteria would have met this measure occurrence)

Metric #9: PQRS #277;
Entitled—% of patients' >/=18 years with a diagnosis of OSA (clinical diagnosis of OSA) who had an AHI or RDI measured at the time of initial diagnosis
Formula—the # of (+) screened patients actually testing (+) by either a HST or a PSG/the total # of (+) screened [this would be the same % as in Metric #2 above; however, a separate mention of this identifies this measure specifically]
Result—the actual % for the (+) HST value and the actual % for the (+)

PSG Value
Data source—the pre-surgery module where the sleep specialist makes a note of the results of the HST or PSG when it gets done; this will usually be at a later date and the Sleep Specialist has to fill this out at a later date or RAC would follow each of these patients' ensuring this is filled out)

Metric #10: PQRS #278:
Entitled—% of patients' >/=18 years with a diagnosis of (clinical diagnosis of OSA) moderate to severe OSA who receive CPAP therapy
Formulas—For in-patient care, the # of (+) screened patients receiving CPAP treatment/the total # of (+) screened patients′; and for out-patient care, the total # of (+) screened patients receiving rental CPAP treatment/the total # of (+) screened patients' (this would be the same as the second part of Metric #4; however, a separate mention of this identifies this measure specifically) and the total # of (+) screened patients' who received a permanent CPAP/the total # of (+) screened patients'
Results—actual # of patients meeting noted critera who receive CPAP therapy
Data source—two venues: either in the post-operative I module and in-patient ward module, where the respiratory therapist would note CPAP therapy and its associated parameters when instituted on the patient; this then would be for an inpatient admission; for an outpatient admission, from the discharge module, where the sleep lab makes a note about the rental CPAP use and then a permanent CPAP use after CPAP titration along with the measures on compliance at 1, 3, 6, 9, and 12 months, % of patients' having a CPAP titration.

Metric #11: PQRS #279:
Entitled—% of visits for patients' >/=18 years with a diagnosis of OSA (clinical diagnosis of OSA) who were treated with CPAP and who had documentation that adherence to CPAP therapy was objectively measured
Formulas—For In-patient care, the total # of (+) screened patients' adhering to CPAP/the total # of (+) screened patients′; and For Out-patient care, the total # of (+) screened adhering to their CPAP at 1, 3, 6, 9 and 12 months/the total # of (+) screened patients'
Results—actual # of patients meeting noted criteria with documentation of measuring CPAP therapy compliance
Data source—two venues: either in the in-patient ward module where the respiratory therapist makes a note of adherence when the patient is admitted and in the discharge module where the sleep lab notes adherence at 1, 3, 6, 9, and 12 months.

Metric #12: PQRS #374:
Entitled—% of patients with referrals, regardless of age, for which the referring provider receives a report from the provider to whom the patient was referred
Formula—the total # of (+) tested patients' whose reports of either the HST or PSG report is sent to the PCP by the Sleep Specialist/the total # of (+) screened patients' who were tested ultimately by an HST or a PSG
Results—actual # of patients with referrals
Data source—the pre-surgery module where the sleep specialist notes sharing the HST or PSG report when done with the primary care physician (Data is the same as Metric #2 but if the report was shared, the data would come from the OSA SR section where the Sleep Specialist is noting faxing and sharing his note with the PCP).

Metric #12-1:
Entitled—% of (+) screened readmitted.
Formula—the # of (+) screened readmitted/the total # of (+) screened
Result—the %
Data source—will depend on later analysis of these patients' as if they were to be readmitted.

Metric #13: ACO-5:
Entitled—Health Promotion and Education;
Formula—the total # of (+) screened patients' who were educated/the total # of (+) screened patients'
Results—the %.
Data source—any section which notes yes on the area education provided.

Metric #14: ACO-6:
Entitled—Shared Decision Making.
Formula—the total # of (+) screened patients sharing decision making with the Anesthesiologist/the total # of (+) screened.
Results—the %
Data source—the day surgery module where the anesthesiologist makes a note of shared decision making with the patient and family.

Metric #15: ACO-7:
Entitled—Health Status & Functional Status;
Formula—the total # of (+) screened &/or (+) tested having education by the PCP/the total # of (+) screened or tested patients'
Results—the %.
Data source—the discharge module where the primary care physician sends notes on any changes in the HbA1C or any changes in the BP control and any changes on cardiac disorders.

Metric #16: ACO-8:
Entitled—Risk Standardized all condition Re-admission.
Formula—the total # of (+) screened readmitted/the total # of (+) screened
Results—the %
Data source—after the risk manager inputs data in the discharge module.

Metric #17: ACO-16:
Entitled—Preventive Screening: BMI Screening and Follow-up.
Formula—the total # of (+) screened inclusive of BMI screened/the total # of all surgical patients′; the next row in the center column should have the formula: the total # of (+) screened patients' followed-up/the total # of (+) screened patients'
Results—the %.
Data source—the discharge module where the primary care physician sends notes on changes in HbA1C, BP control and cardiac disorders to the Sleep Lab

The system may also generate automated notifications based off the metrics discussed in FIGS. 5A-5C. These notifications may be sent to the risk manager at regular intervals (e.g., monthly or quarterly) and feature data about patients during a particular interval. This information may include the number of patient re-admissions, unplanned ICU transfers, major post-operation complications, and any unplanned admissions. This information may help the risk manager better determine the efficacy of the treatments being given and improve them. The system may also generate automated notifications for the primary care physician and sleep specialists to help ensure patients are being referred appropriately.

The perioperative healthcare management system 100 also includes a summary user interface to indicate the number of new patient visits to the primary care physician, the number of subsequent follow-up visits to the primary care physician, the number of in-patient visits by the primary care physician to the hospital for patient care, the number of sleep specialist visits, the number of sleep tests generated and the associated reading. This user interface illustrates the efficiency of the perioperative healthcare management system 100 in creating revenue by a referral process.

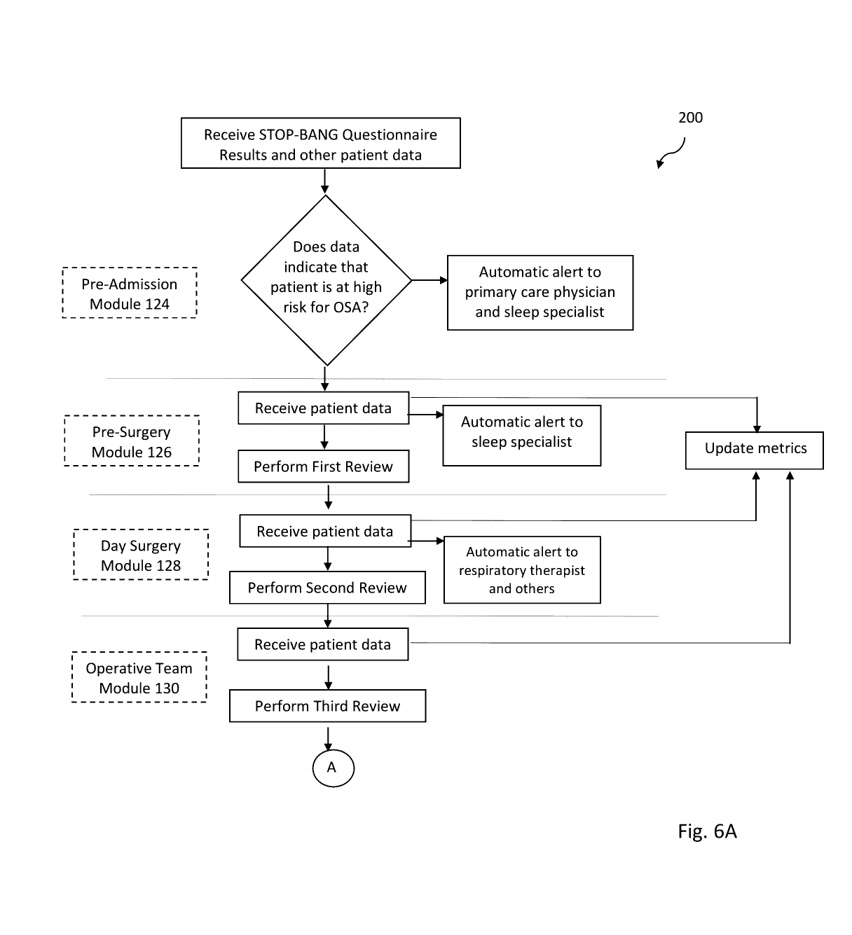

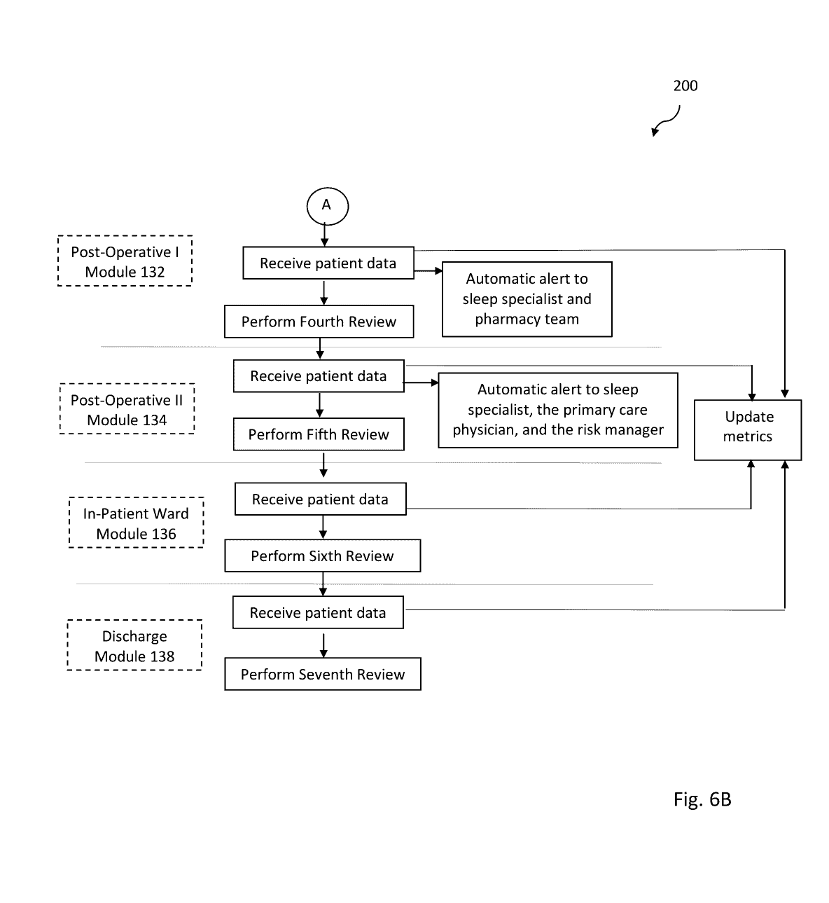

FIGS. 6A and 6B illustrate a method 200 of operating the perioperative healthcare management system 100 of FIGS. 1, 2A, and 2B. At each module 124-138, the method 200 includes the step of receiving patient data 142, and in turn, updating the relevant metrics 160 described above. In some modules, the method 200 includes a step of automatically notifying specific healthcare professionals to updates in the perioperative healthcare management system 100. While the illustrated embodiment includes the steps of automatically alerting healthcare professionals at specific points, other embodiments contemplated may include additional or fewer steps of automatically notifying or alerting specific healthcare professionals.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A perioperative healthcare management system accessible by a plurality of healthcare providers to collect information related to a patient, comprising:
a processor;
a database for storing data related to a plurality of patients;
a memory coupled to the processor, wherein the memory is configured to store program instructions executable by the processor;
wherein, in response to executing the program instructions, the processor is configured to:
generate a dashboard including a plurality of regions, each region corresponding to one of a plurality of modules of perioperative care, wherein the plurality of modules includes:
a pre-admission module,
a pre-surgery module,
a day surgery module,
a post-operative module,
an inpatient ward module, and
a discharge module;
generate a user interface for each stage upon activation of the region of the respective module, wherein data specific to the patient is input through each user interface;
input patient responses to a STOP-BANG questionnaire through the user interface for the pre-admission stage;
tabulate a score based on the patient responses;
if the score is greater than or equal to 4, automatically notify at least one of the healthcare providers, wherein the at least one healthcare provider is one of a sleep specialist, a primary care physician, and a surgery scheduling office; and
derive a plurality of metrics based on the data specific to the patient and data related to a plurality of patients, wherein the metrics demonstrate efficacy of the system.
